(19) United States
(12) Patent Application Publication
(10) Pub. No.: US 2025/0044512 A1
(43) Pub. Date: Feb. 6, 2025

(54) FUSION SPLICER

(71) Applicant: Sumitomo Electric Optifrontier Co., Ltd., Kanagawa (JP)

(72) Inventors: Yuta RYONO, Kanagawa (JP); Ryosuke MEO, Kanagawa (JP); Ryuichiro SATO, Kanagawa (JP)

(21) Appl. No.: 18/713,842

(22) PCT Filed: Dec. 13, 2022
(86) PCT No.: PCT/JP2022/045802

§ 371 Date: May 28, 2024

(30) Foreign Application Priority Data
Dec. 16, 2021 (JP) 2021-204601

(51) Int. Cl. G02B 6/255

(52) U.S. Cl. CPC G02B 6/2553; G02B 6/2551; G02B 6/2556

(57) ABSTRACT

A fusion splicer for fusing and splicing one or a plurality of optical fibers with another or other optical fibers includes a base member having one or a plurality of V-grooves in which the one or the plurality of optical fibers are set, and one or a plurality of recesses crossing the one or the plurality of V-grooves are formed in the base member.

### TECHNICAL FIELD

This disclosure relates to a fusion splicer.

This application claims priority to Japanese Application No. 2021-204601, filed Dec. 16, 2021, the entire contents of which are incorporated herein by reference.

### BACKGROUND ART

Hitherto, a method of fusing and splicing a splicing-target optical fiber by positioning it in a V-groove has been known (see PTL 1).

### CITATION LIST

### Patent Literature

[PTL 1] International Publication No. 2020/162044

### SUMMARY OF THE INVENTION

### Solution to the Problem

The fusion splicer according to an embodiment of the present disclosure is a fusion splicer for fusing and splicing one or a plurality of optical fibers with another or other optical fibers, and includes a base member having one or a plurality of V-grooves in which the one or the plurality of optical fibers are set, wherein one or a plurality of recesses crossing the one or the plurality of V-grooves are formed in the base member.

### BRIEF DESCRIPTION OF THE DRAWINGS

FIG. 1 is a perspective view of a part of a fusion splicer.

FIG. 2A is a top view of a part of the fusion splicer.

FIG. 2B is a top view of a part of the fusion splicer.

FIG. 3 is a cross-sectional view of a part of the fusion splicer.

FIG. 4 is a block diagram illustrating a control system configured to control the fusion splicer.

FIG. 5 is a perspective view of a part of the fusion splicer.

FIG. 6A is a top view of a part of the fusion splicer.

FIG. 6B is a cross-sectional view of a part of the fusion splicer.

FIG. 7A is a cross-sectional view of a part of the fusion splicer.

FIG. 7B is a cross-sectional view of a part of the fusion splicer.

FIG. 7C is a cross-sectional view of a part of the fusion splicer.

FIG. 8A is a top view of a part of the fusion splicer.

FIG. 8B is a top view of a part of the fusion splicer.

FIG. 8C is a top view of a part of the fusion splicer.

FIG. 8D is a top view of a part of the fusion splicer.

FIG. 8E is a top view of a part of the fusion splicer.

FIG. 8F is a top view of a part of the fusion splicer.

FIG. 8G is a top view of a part of the fusion splicer.

### DESCRIPTION OF EMBODIMENTS

### Technical Problem

PTL 1 discloses an operation of a fusion splicer for removing foreign matter attached to an optical fiber. However, the fusion splicer needs to perform the operation for removing foreign matter actively in addition to the normal fusion splicing operation. Therefore, it is desirable to minimize the additional operation for removing foreign matter.

### Advantageous Effects of the Invention

The above-described fusion splicer can inhibit an optical fiber set in a V-groove from being displaced from a predetermined position by foreign matter.

### Description of Embodiments of the Present Disclosure

First, embodiments of the present disclosure will be described by listing.

(1) The fusion splicer according to one aspect of the present disclosure is a fusion splicer configured to fuse and splice one or a plurality of optical fibers with another or other optical fibers, and includes a base member having one or a plurality of V-grooves in which the one or the plurality of optical fibers are set, wherein one or a plurality of recesses crossing the one or the plurality of V-grooves may be formed in the base member. In this configuration, by forming the recesses to cross the V-grooves, it is possible to reduce the probability that foreign matter will remain in the V-grooves after the V-grooves are cleaned by a cotton swab or the like. This is because foreign matter present in the V-grooves is scraped out into the recesses by the cotton swab or the like. Therefore, this configuration has the effect of reducing the probability that the foreign matter will be caught between the optical fibers and the V-grooves when the optical fibers are set in the V-grooves. This configuration also has the effect that the optical fibers are accurately positioned in the V-grooves. The portion of the optical fiber set in the V-groove is the portion where the cladding material is removed and the glass fiber is exposed, and is also referred to as a bare fiber portion. The portion covered with the cladding material is also referred to as an optical fiber strand or an optical fiber core wire.

(2) The depth of the one or more recesses may be deeper than the depth of the one or more V-grooves. Since the foreign matter scraped out from the V-grooves falls into the recesses deeper than the V-grooves, this configuration has the effect of further reducing the probability that the foreign matter will be caught between the optical fibers and the V-grooves when the optical fibers are set in the V-grooves.

(3) The one or the plurality of recesses may be formed to extend in a direction non-parallel with the extending direction of the one or more V-grooves. Since the foreign matter accumulated in the recesses can be discharged to the outside along the extending direction of the recesses without going through the V-grooves, this configuration has the effect of further reducing the probability that the foreign matter will be caught between the optical fibers and the V-grooves when the optical fibers are set in the V-grooves.

(4) The bottom surface of the one or the plurality of recesses may be formed so as to be smoothly deepened from ends to the center. Since scraping-out of the foreign matter accumulated on the bottom surface of the recesses to outside the recesses is facilitated, this configuration has the effect of further reducing the probability that the foreign matter will be caught between the optical fibers and the V-grooves when the optical fibers are set in the V-grooves.

(5) The one or the plurality of recesses may be through-holes penetrating the base member. This configuration allows foreign matter entering the V-grooves to be discharged out of the V-grooves through the through-holes. Therefore, this configuration has the effect of further reducing the probability that the foreign matter will be caught between the optical fibers and the V-groove when the optical fibers are set in the V-grooves.

### Details of the Embodiments of the Present Disclosure

In the following, specific examples of a fusion splicer 1 and a method of splicing optical fibers according to an embodiment of the present disclosure will be described with reference to the attached drawings.

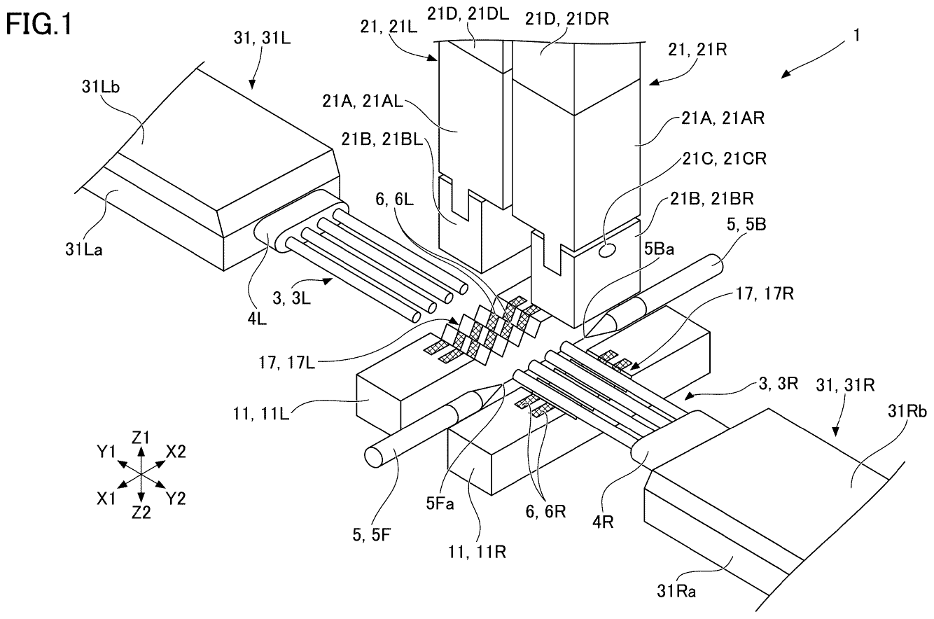

FIG. 1 is a perspective view of a part of the fusion splicer 1. In FIG. 1, X1 represents one direction of the X-axis constituting the three-dimensional orthogonal coordinate system, and X2 represents the other direction of the X-axis. Y1 represents one direction of the Y-axis constituting the three-dimensional orthogonal coordinate system, and Y2 represents the other direction of the Y-axis. Similarly, Z1 represents one direction of the Z-axis constituting the three-dimensional orthogonal coordinate system, and Z2 represents the other direction of the Z-axis. In this embodiment, the X1 side of the fusion splicer 1 corresponds to the front side of the fusion splicer 1, and the X2 side of the fusion splicer 1 corresponds to the rear side (back side) of the fusion splicer 1. The Y1 side of the fusion splicer 1 corresponds to the left side of the fusion splicer 1, and the Y2 side of the fusion splicer 1 corresponds to the right side of the fusion splicer 1. The Z1 side of the fusion splicer 1 corresponds to the upper side of the fusion splicer 1, and the Z2 side of the fusion splicer 1 corresponds to the lower side of the fusion splicer 1. The same applies in other figures.

The fusion splicer 1 is a device configured to utilize arc discharge to fuse and splice with each other, optical fibers that are arranged with their end faces meeting each other. In the illustrated example, the fusion splicer 1 is configured to fuse and splice four pairs of optical fibers. Specifically, the fusion splicer 1 includes a pair of electrode rods 5 (a back electrode rod 5B and a front electrode rod 5F), a pair of base members 11 (a left base member 11L and a right base member 11R), a pair of fiber clamp assemblies 21 (a left fiber clamp assembly 21L and a right fiber clamp assembly 21R), and a pair of fiber holders 31 (a left fiber holder 31L and a right fiber holder 31R). The pair of base members 11 (the left base member 11L and the right base member 11R) may be integrally formed as one component.

The pair of electrode rods 5 includes the back electrode rod 5B and the front electrode rod 5F arranged apart from each other in the X-axis direction. The pair of electrode rods 5 are arranged such that the tip 5Ba of the back electrode rod 5B and the tip 5Fa of the front electrode rod 5F face each other in the X-axis direction. In the illustrated example, the back electrode rod 5B includes a conical portion, of which the diameter decreases toward the tip 5Ba. The same applies to the front electrode rod 5F.

The plurality of pairs of optical fibers disposed on the pair of base members 11 are glass fibers, and are disposed between the back electrode rod 5B and the front electrode rod 5F that are configured to generate arc discharge. The portions of the plurality of pairs of optical fibers disposed on the pair of base members 11 are bare fiber portions where the cladding material is removed and the glass fiber is exposed.

Specifically, the plurality of pairs of bare fiber portions include bare fiber portions included in a left optical fiber group 3L constituting a left tape core wire 4L and bare fiber portions included in a right optical fiber group 3R constituting a right tape core wire 4R. Hereinafter, the left optical fiber group 3L and the right optical fiber group 3R may be referred to as the optical fiber groups 3 for convenience of description.

A tape core wire is formed by setting a plurality of optical fibers (optical fiber strands) in parallel and covering them collectively with, for example, an ultraviolet curable resin (cladding material). Each of the left tape core wire 4L and the right tape core wire 4R in the illustrated example is formed by setting four optical fibers (optical fiber strands) in parallel and covering them collectively with an ultraviolet curable resin (cladding material).

The pair of base members 11 are members configured to support the plurality of pairs of optical fibers, and include the left base member 11L and the right base member 11R positioned so as to sandwich the pair of electrode rods 5 in the Y-axis direction. That is, the pair of electrode rods 5 are arranged between the left base member 11L and the right base member 11R that are arranged so as to be separated from each other in the Y-axis direction. The right base member 11R in the illustrated example has a right V-groove group 17R, also referred to as a right optical fiber setting part or a right groove part, and the left base member 11L has a left V-groove group 17L, also referred to as a left optical fiber setting part or a left groove part. In the following, the left V-groove group 17L and the right V-groove group 17R may be referred to as the V-groove groups 17 for convenience of description.

The left V-groove group 17L has a plurality of V-grooves for setting a plurality of optical fibers (left optical fiber group 3L), and the right V-groove group 17R has a plurality of V-grooves for setting a plurality of optical fibers (right optical fiber group 3R). In the illustrated example, the left V-groove group 17L includes four V-grooves for setting four optical fibers. The four V-grooves are arranged at equal intervals in the X-axis direction and are formed to extend linearly along the Y-axis direction. Similarly, the right V-groove group 17R includes four V-grooves for setting four optical fibers. The four V-grooves are arranged at equal intervals in the X-axis direction and are formed to extend linearly along the Y-axis direction.

The plurality of V-grooves in the right V-groove group 17R and the plurality of V-grooves in the left V-groove group 17L are configured to simultaneously position a plurality of pairs of optical fibers in place. In the illustrated example, the four V-grooves in the right V-groove group 17R and the four V-grooves in the left V-groove group 17L are arranged to face each other in the extending direction (Y-axis direction) and are configured to simultaneously position the four pairs of optical fibers in place.

Thus, the four optical fibers positioned in place by the four V-grooves in the right V-groove group 17R and the four optical fibers positioned in place by the four V-grooves in the left V-groove group 17L are made to meet each other in the region between the right base member 11R (right V-groove group 17R) and the left base member 11L (left V-groove group 17L).

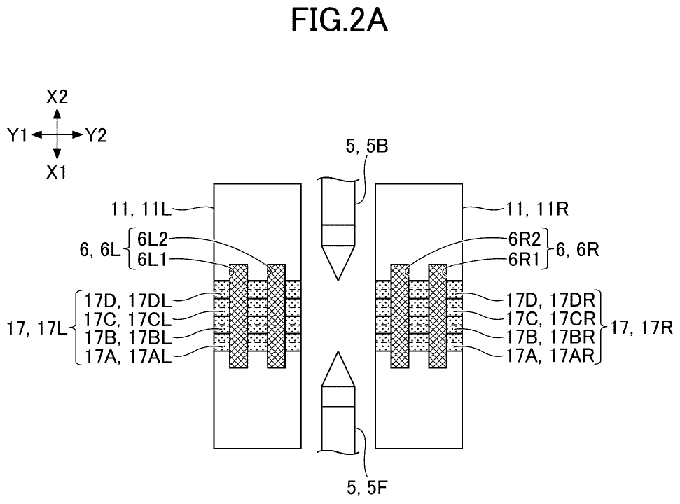

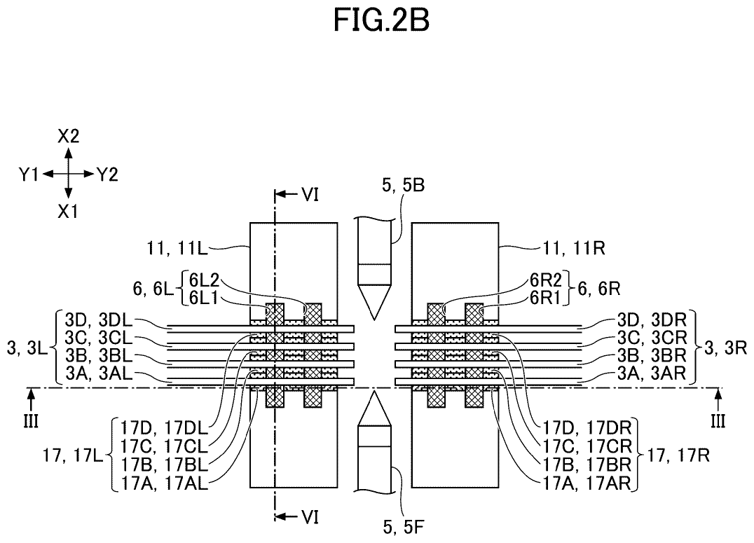

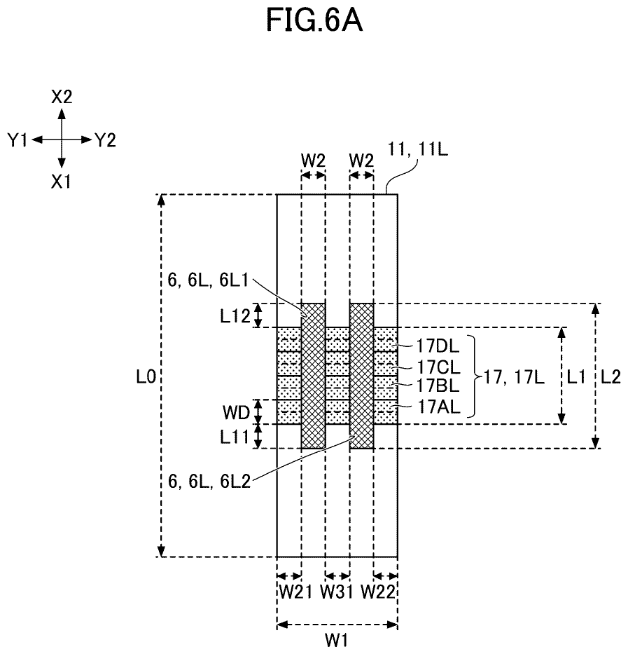

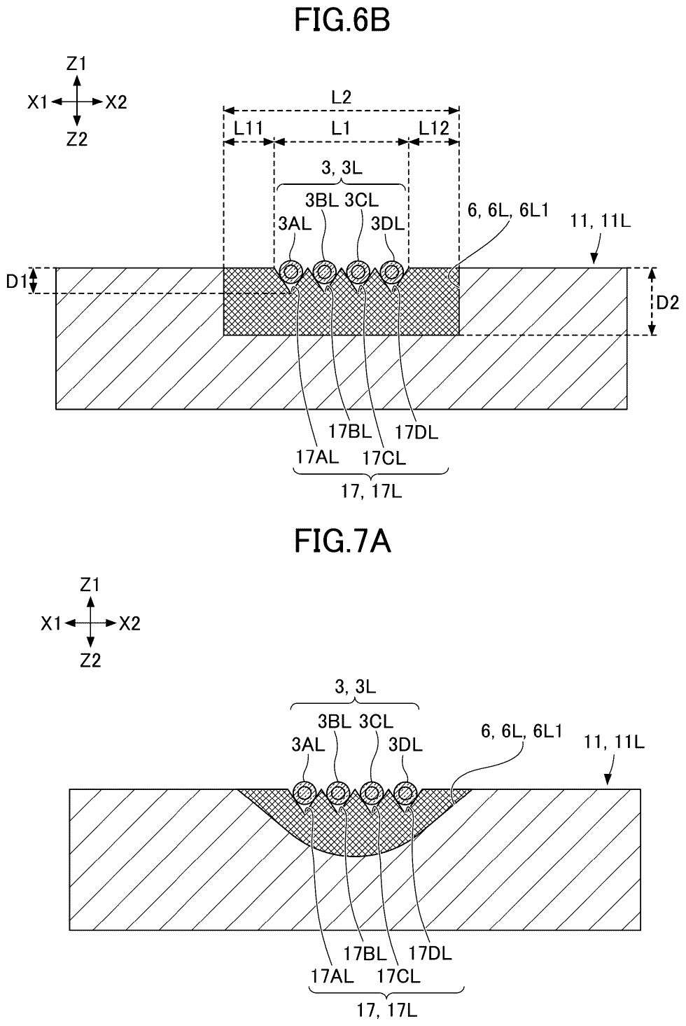

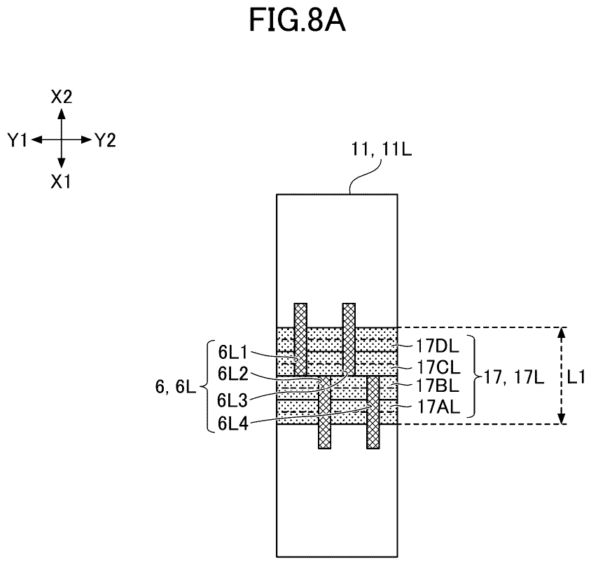

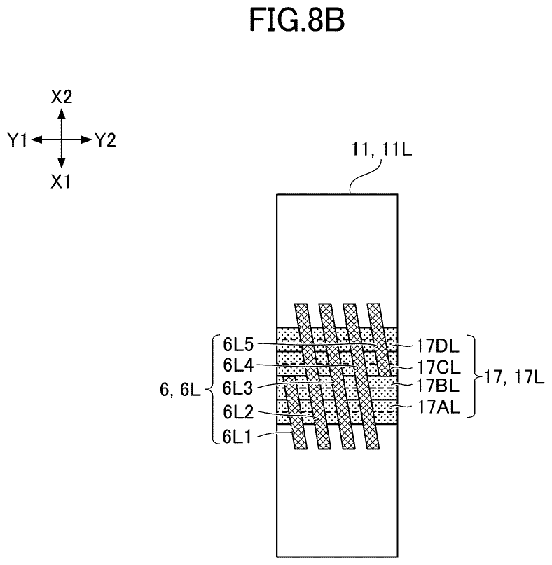

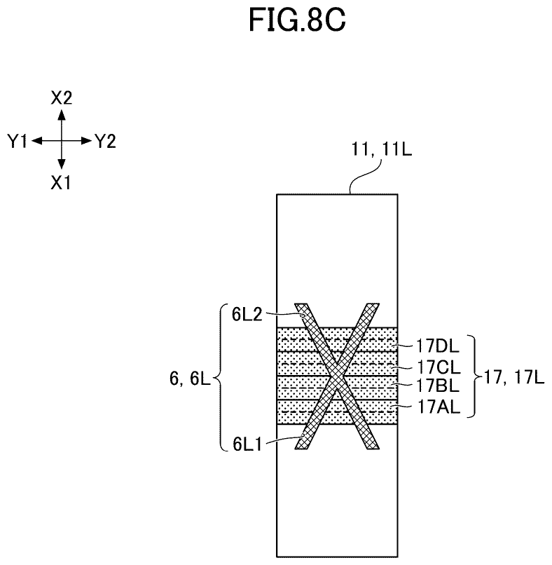

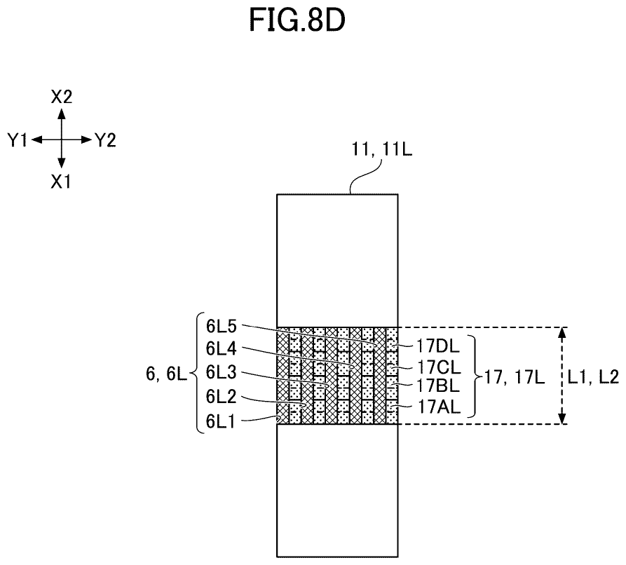

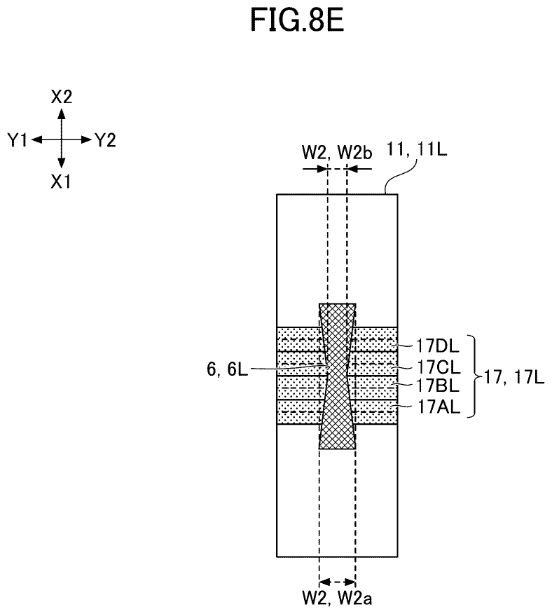

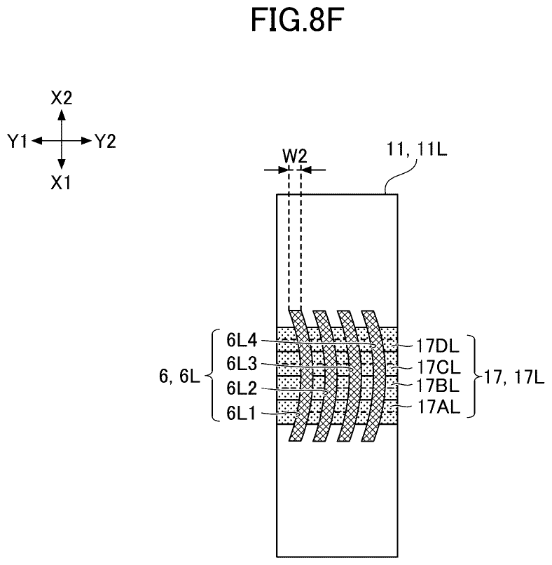

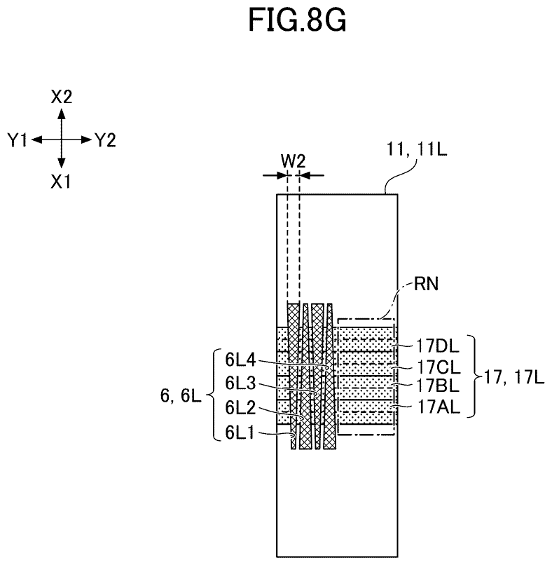

Referring now to FIGS. 2A and 2B, the V-groove groups 17 in which four pairs of optical fibers are positioned in place will be described in detail. FIGS. 2A and 2B are top views of a part of the fusion splicer 1. Specifically, FIGS. 2A and 2B are top views of the electrode rods 5 and the base members 11. More specifically, FIG. 2A illustrates a state before the optical fiber groups 3 are set in the V-groove groups 17, and FIG. 2B illustrates a state after the optical fiber groups 3 are set in the V-groove groups 17. In FIGS. 2A and 2B, a dot pattern is applied to the groove surface of the V-groove groups 17 for clarity. In FIG. 2A, the bottom of each V-groove is represented by a broken line. The same applies in FIGS. 6A and 8A to 8F.

As illustrated in FIG. 2A, the left V-groove group 17L includes a first left V-groove 17AL, a second left V-groove 17BL, a third left V-groove 17CL, and a fourth left V-groove 17DL, and the right V-groove group 17R includes a first right V-groove 17AR, a second right V-groove 17BR, a third right V-groove 17CR, and a fourth right V-groove 17DR. The first left V-groove 17AL and the first right V-groove 17AR form a first V-groove pair 17A, the second left V-groove 17BL and the second right V-groove 17BR form a second V-groove pair 17B, the third left V-groove 17CL and the third right V-groove 17CR form a third V-groove pair 17C, and the fourth left V-groove 17DL and the fourth right V-groove 17DR form a fourth V-groove pair 17D.

As illustrated in FIG. 2B, the left optical fiber group 3L includes a first left optical fiber 3AL, a second left optical fiber 3BL, a third left optical fiber 3CL, and a fourth left optical fiber 3DL as bare fiber portions, and the right optical fiber group 3R includes a first right optical fiber 3AR, a second right optical fiber 3BR, a third right optical fiber 3CR, and a fourth right optical fiber 3DR as bare fiber portions. The first left optical fiber 3AL and the first right optical fiber 3AR form a first optical fiber pair 3A, the second left optical fiber 3BL and the second right optical fiber 3BR form a second optical fiber pair 3B, the third left optical fiber 3CL and the third right optical fiber 3CR form a third optical fiber pair 3C, and the fourth left optical fiber 3DL and the fourth right optical fiber 3DR form a fourth optical fiber pair 3D.

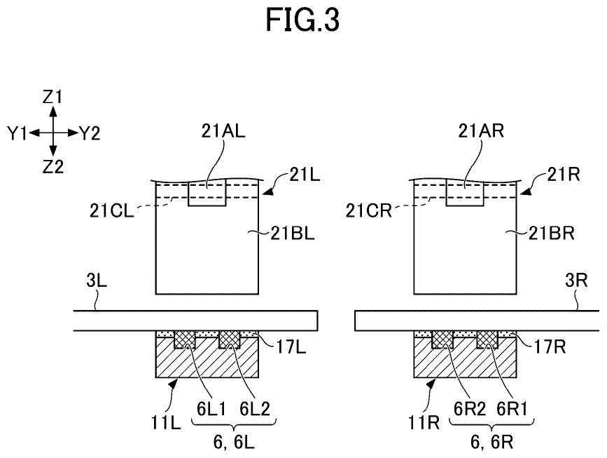

Next, with reference to FIGS. 1 and 3, the movement of the fiber clamp assemblies 21 (the left fiber clamp assembly 21L and the right fiber clamp assembly 21R) will be described. FIG. 3 is a cross-sectional view of a part of the fusion splicer 1. Specifically, FIG. 3 is a view of a cross-section including a cutting line III-III of FIG. 2B, viewed from the X1 side as indicated by the arrow. Note that the cross-section taken from FIG. 2B includes cross-sections of the base members 11.

As illustrated in FIG. 1, the fiber clamp assemblies 21 are configured to be able to press the optical fiber groups 3 set in the V-groove groups 17 against the V-groove groups 17. In the illustrated example, the fiber clamp assemblies 21 each include an arm portion 21A, a fiber clamp 21B, a coupling pin 21C, and a clamp block 21D. The fiber clamp assemblies 21 are disposed above the V-groove groups 17 and are configured to be able to move in the Z-axis direction. The fiber clamp 21B is attached to the lower end of the arm portion 21A via the coupling pin 21C. In the illustrated example, the fiber clamp 21B is formed of a heat-resistant ceramic such as zirconia. The arm portion 21A is attached to the lower end of the clamp block 21D via an elastic body (not illustrated) such as a spring.

Specifically, the left fiber clamp assembly 21L is configured to be able to press the left optical fiber group 3L set in the left V-groove group 17L against the left V-groove group 17L. Similarly, the right fiber clamp assembly 21R is configured to be able to press the right optical fiber group 3R set in the right V-groove group 17R against the right V-groove group 17R. In the illustrated example, the left fiber clamp assembly 21L includes a left arm portion 21AL, a left fiber clamp 21BL, a left coupling pin 21CL (see FIG. 3), and a left clamp block 21DL, and the right fiber clamp assembly 21R includes a right arm portion 21AR, a right fiber clamp 21BR, a right coupling pin 21CR, and a right clamp block 21DR. The left fiber clamp assembly 21L is disposed above the left V-groove group 17L, and the right fiber clamp assembly 21R is disposed above the right V-groove group 17R. The left fiber clamp assembly 21L and the right fiber clamp assembly 21R are configured to be able to move in the Z-axis direction. The left fiber clamp 21BL is attached to the lower end of the left arm portion 21AL via the left coupling pin 21CL, and the right fiber clamp 21BR is attached to the lower end of the right arm portion 21AR via the right coupling pin 21CR. In the illustrated example, the left fiber clamp 21BL is movable in the Z-axis direction with the left arm portion 21AL, and the right fiber clamp 21BR is movable in the Z-axis direction with the right arm portion 21AR. In the state illustrated in FIG. 3, the left fiber clamp 21BL is separated from the left optical fiber group 3L set in the left V-groove group 17L. However, along with movement of the left fiber clamp assembly 21L downward, the left fiber clamp 21BL can contact the left optical fiber group 3L and press the left optical fiber group 3L against the left V-groove group 17L. The same applies to the right fiber clamp 21BR.

The left fiber clamp assembly 21L may be configured to allow the fiber clamp pressure to vary. The fiber clamp pressure is the pressure that the left optical fiber group 3L set in the left V-groove group 17L receives from the left fiber clamp 21BL of the left fiber clamp assembly 21L. Specifically, an elastic body such as a spring or the like configured to bias the left arm portion 21AL downward may be disposed between the left arm portion 21AL and the left clamp block 21DL. In this case, the left fiber clamp assembly 21L can control the fiber clamp pressure by controlling the position of the left clamp block 21DL in the Z-axis direction. The same applies to the right fiber clamp assembly 21R.

As illustrated in FIG. 1, the left fiber holder 31L is configured to be able to hold the left optical fiber group 3L, and the right fiber holder 31R is configured to be able to hold the right optical fiber group 3R. Specifically, the left fiber holder 31L is configured to be able to hold the left tape core wire 4L including the left optical fiber group 3L, and the right fiber holder 31R is configured to be able to hold the right tape core wire 4R including the right optical fiber group 3R. More specifically, the left fiber holder 31L has a left fiber holder body 31La having a recess (not illustrated.) for housing the left tape core wire 4L, and a left cover 31 Lb attached to the left fiber holder body 31La. Similarly, the right fiber holder 31R has a right fiber holder body 31Ra having a recess (not illustrated.) for housing the right tape core wire 4R, and a right cover 31Rb attached to the right fiber holder body 31Ra.

When the left cover 31 Lb is closed while the left tape core wire 4L is housed in the left fiber holder body 31La, the left tape core wire 4L is held on the left fiber holder 31L. The left fiber holder 31L is fixed to a movable stage (not illustrated) and is movable in the direction along the axial direction of the left optical fiber group 3L held thereon. That is, the left fiber holder 31L is movable along the extending direction (Y-axis direction) of the left V-groove group 17L. When the left fiber holder 31L holding the left optical fiber group 3L moves, the left optical fiber group 3L held thereon can move along the left V-groove group 17L.

Similarly, when the right cover 31Rb is closed while the right tape core wire 4R is housed in the right fiber holder body 31Ra, the right tape core wire 4R is held on the right fiber holder 31R. The right fiber holder 31R is fixed to a movable stage (not illustrated) and is movable in a direction along the axial direction of the right optical fiber group 3R held thereon. That is, the right fiber holder 31R is movable along the extending direction (Y-axis direction) of the right V-groove group 17R. When the right fiber holder 31R holding the right optical fiber group 3R moves, the right optical fiber group 3R held thereon can move along the right V-groove group 17R.

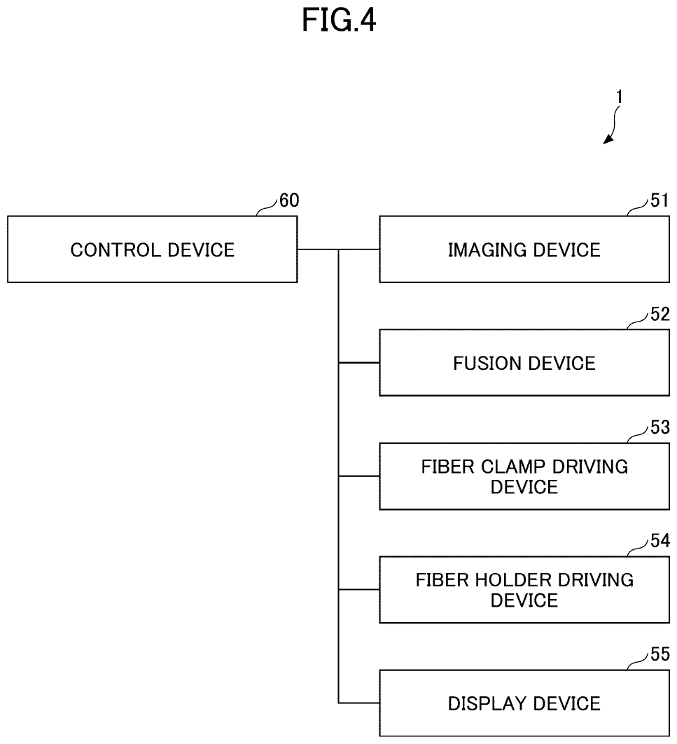

Next, a control system configured to control the fusion splicer 1 will be described with reference to FIG. 4. FIG. 4 is a block diagram illustrating the control system configured to control the fusion splicer 1.

As illustrated in FIG. 4, the fusion splicer 1 includes an imaging device 51, a fusion device 52, a fiber clamp driving device 53, a fiber holder (stage) driving device 54, a display device 55, and a control device 60. In this embodiment, the imaging device 51, the fusion device 52, the fiber clamp driving device 53, the fiber holder (stage) driving device 54, and the display device 55 are controlled by the control device 60.

The imaging device 51 includes, for example, a pair of cameras (X camera and Y camera). Both the X camera and the Y camera are positioned so as to be able to simultaneously capture images of an end of the left optical fiber group 3L set in the left V-groove group 17L and an end of the right optical fiber group 3R set in the right V-groove group 17R. The imaging direction of the X camera and the imaging direction of the Y camera are orthogonal to each other. Based on the images of the optical fiber groups 3 imaged by the pair of cameras from two different directions, the control device 60 can locate the positions of the optical fiber groups 3.

The fusion device 52 is a device configured to fuse and splice an end of the left optical fiber group 3L and an end of the right optical fiber group 3R with each other. In this embodiment, the pair of electrode rods 5 are included in the fusion device 52.

The fiber clamp driving device 53 is a device configured to press the optical fiber groups 3 against the V-groove groups 17. In this embodiment, the fiber clamp driving device 53 includes an actuator configured to move each of the left clamp block 21DL forming a part of the left fiber clamp assembly 21L and the right clamp block 21DR forming a part of the right fiber clamp assembly 21R in the Z-axis direction.

The fiber holder (stage) driving device 54 is a device configured to move the optical fiber groups 3 in the direction along the axial direction (Y-axis direction). In this embodiment, the fiber holder (stage) driving device 54 includes an actuator configured to move the left fiber holder 31L fixed to the stage in a direction along the axial direction (Y-axis direction) of the left optical fiber group 3L, and an actuator configured to move the right fiber holder 31R fixed to the stage in a direction along the axial direction (Y-axis direction) of the right optical fiber group 3R.

The display device 55 is a device configured to display various types of information. In this embodiment, the display device 55 is configured to display an image captured by the imaging device 51. In this embodiment, the display device 55 is a liquid crystal display.

The control device 60 is a device configured to control the imaging device 51, the fusion device 52, the fiber clamp driving device 53, the fiber holder (stage) driving device 54, and the display device 55. In this embodiment, the control device 60 is a computer including, for example, a Central Processing Unit (CPU), a Random Access Memory (RAM), a Read Only Memory (ROM), a communication module, and an external memory device.

Specifically, the control device 60 acquires an image captured by the imaging device 51 by controlling the imaging device 51. The control device 60 can, for example, cause the acquired image to be displayed on the display device 55. The control device 60 can also determine the state of a pair or a plurality of pairs of optical fibers by applying image processing to the acquired image. The control device 60 can also generate arc discharge between the back electrode rod 5B and the front electrode rod 5F by controlling the fusion device 52. The control device 60 can also move the left clamp block 21DL of the left fiber clamp assembly 21L and the right clamp block 21DR of the right fiber clamp assembly 21R in the Z-axis direction by controlling the fiber clamp driving device 53. Under control of the control device 60, the left fiber clamp assembly 21L can change the state of pressing the left optical fiber group 3L set in the left V-groove group 17L, and the right fiber clamp assembly 21R can change the state of pressing the right optical fiber group 3R set in the right V-groove group 17R. The control device 60 can control the positions of the left fiber holder 31L and the right fiber holder 31R in the Y-axis direction by controlling the fiber holder (stage) driving device 54. Specifically, the control device 60 can move the left optical fiber group 3L held on the left fiber holder 31L in the Y-axis direction by moving the stage (not illustrated) on which the left fiber holder 31L is fixed in the Y-axis direction, and can move the right optical fiber group 3R held on the right fiber holder 31R in the Y-axis direction by moving the stage (not illustrated) on which the right fiber holder 31R is fixed in the Y-axis direction.

As described above, the V-groove groups 17 are used for positioning of the optical fiber groups 3 to be fused and spliced. If foreign matter adheres in the V-grooves, it may become impossible to position the optical fiber group 3 accurately in place. The foreign matter may be, for example, dust in the ambient atmosphere, glass and cladding residue that adheres to, or has remained from the previous fusion splicing on, the optical fiber groups 3 to be fused and spliced, and the like.

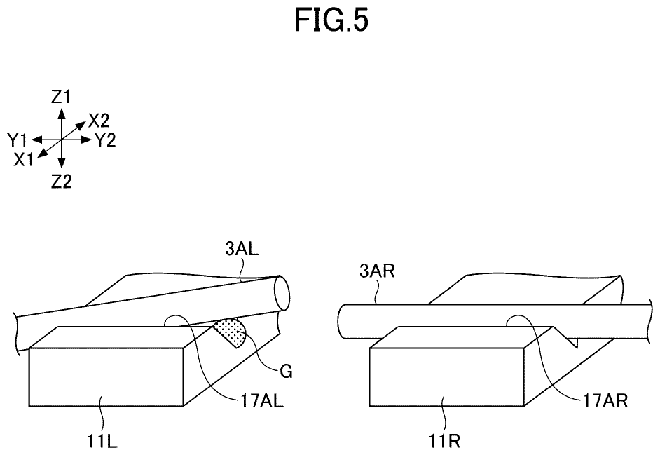

FIG. 5 illustrates an example of the state of an optical fiber when foreign matter exists in a V-groove. Specifically, FIG. 5 illustrates the state of the first left optical fiber 3AL set in the first left V-groove 17AL when foreign matter G adheres to the first left V-groove 17AL, and the state of the first right optical fiber 3AR set in the first right V-groove 17AR to which no foreign matter G adheres.

As illustrated in FIG. 5, when the foreign matter G adheres to an end (the end on the Y2 side) of the first left V-groove 17AL, an end (the end on the Y2 side) of the first left optical fiber 3AL is inclined upward. In this case, misalignment occurs between the axial direction of the first left optical fiber 3AL and the axial direction of the first right optical fiber 3AR, and the fusion splicer 1 cannot appropriately fuse and splice the first left optical fiber 3AL and the first right optical fiber 3AR with each other. A typical size of actual foreign matter that may adhere to a V-groove is smaller than the size of the foreign matter G illustrated in FIG. 5. However, it makes no difference whether a foreign matter has such a small size or not in that the realization of appropriate fusion splicing is hindered.

Therefore, as illustrated in FIGS. 1, 2A, 2B, and 3, recesses 6 are formed in the V-groove groups 17 of the fusion splicer 1 according to the present embodiment, respectively.

The recesses 6 are portions (structures) formed in the base members 11. In the present embodiment, the recesses 6 are structures formed so as to make it difficult for foreign matter to adhere to the portions of the groove surfaces of the V-grooves that are expected to come into contact with the optical fibers.

In the examples illustrated in FIGS. 1, 2A, 2B, and 3, a cross pattern is applied to the bottom surface and the wall surfaces (side surfaces) of the recesses 6 that are depressions formed in the base members 11, for clarity.

Specifically, the recesses 6 include left recesses 6L formed in the left base member 11L and right recesses 6R formed in the right base member 11R.

In the illustrated example, the left recesses 6L are grooves formed to perpendicularly cross all of the four V-grooves (first left V-groove 17AL, second left V-groove 17BL, third left V-groove 17CL, and fourth left V-groove 17DL), and include a first left recess 6L1 and a second left recess 6L2. The right recesses 6R are grooves formed to perpendicularly cross all of the four V-grooves (first right V-groove 17AR, second right V-groove 17BR, third right V-groove 17CR, and fourth right V-groove 17DR), and include a first right recess 6R1 and a second right recess 6R2.

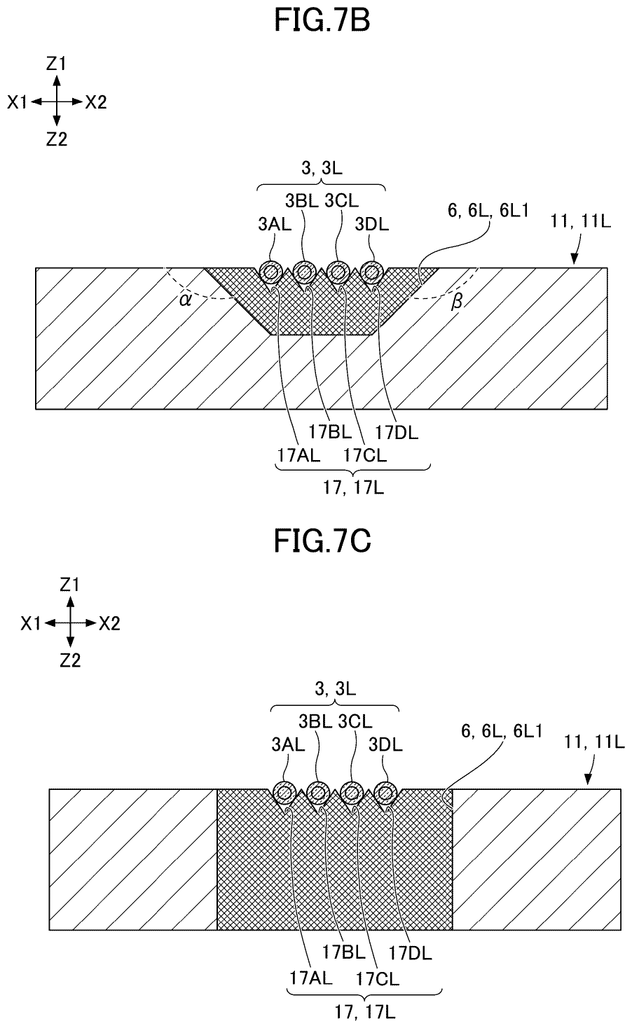

Referring now to FIGS. 6A and 6B, a configuration example of the recesses 6 will be described in detail. FIGS. 6A and 6B are views illustrating a configuration example of the left recesses 6L formed in the upper surface of the left base member 11L that is a part of the fusion splicer 1. Specifically, FIG. 6A is a top view of the left base member 11L in which the left recesses 6L and the left V-groove group 17L are formed, and FIG. 6B is a cross-sectional view of the left base member 11L in which the left recesses 6L and the left V-groove group 17L are formed. More specifically, FIG. 6B is a view of a cross-section including a cutting line VI-VI of FIG. 2B, viewed from the Y2 side as indicated by the arrow. In FIG. 6A, a dot pattern is applied to the surface of the left V-groove group 17L for clarity. In FIGS. 6A and 6B, a cross pattern is applied to the bottom surface and the wall surfaces (side surfaces) of the left recesses 6L for clarity. The same applies to FIGS. 7A, 7B, and 7C below.

Further, the following description with reference to FIGS. 6A and 6B relates to the left recesses 6L formed in the left base member 11L, but is applied to the right recesses 6R formed in the right base member 11R.

In the illustrated example, the left V-groove group 17L is configured to have a length L1 in the X-axis direction. Each of the four V-grooves (first left V-groove 17AL, second left V-groove 17BL, third left V-groove 17CL, and fourth left V-groove 17DL) has a width WD, and the length L1 of the left V-groove group 17L in the X-axis direction corresponds to the sum of the widths of the four V-grooves.

In the illustrated example, the length L2 of the first left recess 6L1 and the second left recess 6L2 in the X-axis direction is larger than the length L1 of the left V-groove group 17L. Specifically, the first left recess 6L1 is longer by a length L11 on the front side (on the X1 direction side) of the front edge (edge on the X1 side) of the left V-groove group 17L, and is longer by a length L12 on the back side (on the X2 direction side) of the back edge (edge on the X2 side) of the left V-groove group 17L. In the illustrated example, the length L11 and the length L12 are the same. However, the length L11 and the length L12 may be different from each other. Further, the length L2 of the first left recess 6L1 and the second left recess 6L2 in the X-axis direction may be the same as the length L1 of the left V-groove group 17L, or may be smaller than the length L1. Further, the length L2 of the first left recess 6L1 and the second left recess 612 in the X-axis direction may be the same as the length L0 of the left base member 11L. That is, each of the first left recess 6L1 and the second left recess 6L2 may have their front end opened in the front side surface of the left base member 11L and have their back end opened in the back side surface of the left base member 11L. Alternatively, each of the first left recess 6L1 and the second left recess 6L2 may have either their front end or their back end opened.

The first left recess 6L1 forms a rectangular-parallelepiped-shaped space having a width W2, a length L2, and a height (a depth D2) inside the left base member 11L having a width W1. That is, the first left recess 6L1 has a flat bottom surface extending along the X-axis direction and four wall surfaces extending along the Z-axis direction. The four wall surfaces are flat vertical surfaces and include a front side surface (X1-side surface), a back side surface (X2-side surface), a left side surface (Y1-side surface), and a right side surface (Y2-side surface). The same applies to the second left recess 6L2. The width W2 of the first left recess 6L1 is formed to be smaller than or equal to a predetermined size such that each included in the left optical fiber group 3L set in the left V-groove group 17L does not lose tension and droop downward at the first left recess 6L1. The same applies to the second left recess 6L2.

The depth D2 of the left recesses 6L is deeper than the depth D1 of the left V-groove group 17 L, in order to enable a worker, who removes foreign matter by a cotton swab or the like, to drop the foreign matter inside the left V-groove group 17L into the left recesses 6L. However, the depth D2 of the left recesses 6L may be the same as the depth D1 of the left V-groove group 17L, and the depth D2 thereof may be shallower than the depth D1 of the left V-groove group 17L. The left recesses 6L may be formed to penetrate the left base member 11L in the vertical direction (Z-axis direction). That is, the left recesses 6L may be a through-hole in the shape of a rectangular parallelepiped penetrating the left base member 11L.

Although the width of the opening of the left recesses 6L and the width of the bottom surface thereof are the width W2, the width of the opening and the width of the bottom surface may be different from each other. For example, the width of the opening of the left recesses 6L may be larger than the width of the bottom surface thereof. Moreover, although both the length of the opening of the left recesses 6L and the length of the bottom surface thereof are the length L2, the length of the opening and the length of the bottom surface may be different from each other. For example, the length of the opening of the left recesses 6L may be larger than the length of the bottom surface thereof, in order to enable any foreign matter that has fallen into the left recesses 6L to be gathered within a relatively narrow range of the bottom surface of the left recesses 6L, and hence to enable the foreign matter gathered within the relatively narrow range of the bottom surface of the left recesses 6L to be easily scraped out by a cotton swab or the like.

The first left recess 6L1 is formed such that the distance between the left edge of the left base member 11L and the left edge of the first left recess 6L1 in the Y-axis direction is a width W21. The second left recess 6L2 is formed such that the distance between the right edge of the left base member 11L and the right edge of the second left recess 6L2 in the Y-axis direction is a width W22. The left recesses 6L (the first left recess 6L1 and the second left recess 6L2) are formed such that the distance between the right edge of the first left recess 6L1 and the left edge of the second left recess 6L2 in the Y-axis direction is a width W31. In the illustrated example, the left recesses 6L (the first left recess 6L1 and the second left recess 6L2) are formed such that the width W21, the width W22, and the width W31 are the same. However, the left recesses 6L (the first left recess 6L1 and the second left recess 6L2) may be formed such that the width W21, the width W22, and the width W31 are different from each other.

In the illustrated example, the first left recess 611 and the second left recess 612 are formed to have the same width (the width W2), but may have widths different from each other. In the illustrated example, the first left recess 6L1 and the second left recess 6L2 are formed to have the same length (the length L2), but may have different lengths from each other. In the illustrated example, the first left recess 6L1 and the second left recess 6L2 are formed to have the same depth (the depth D2), but may have different depths from each other.

Referring now to FIGS. 7A, 7B, and 7C, another configuration example of the recesses 6 will be described. FIGS. 7A, 7B, and 7C are views illustrating another configuration example of the recesses 6. Specifically, FIGS. 7A, 7B, and 7C are cross-sectional views of the left base member 11L in which the left recesses 6L and the left V-groove group 17L are formed, and correspond to FIG. 6B. The following description referring to FIGS. 7A, 7B, and 7C relates to the left recesses 6L formed in the left base member 11L, but can also be applied to the right recesses 6R formed in the right base member 11R.

The difference between the left recesses 6L illustrated in FIG. 7A and the left recesses 6L illustrated in FIG. 6B is that the former recesses have a curved bottom surface whereas the latter recesses have a flat bottom surface. Specifically, the bottom surface of the left recesses 6L illustrated in FIG. 7A smoothly deepens from the front edge (edge on the X1 side) to the center and then smoothly shallows from the center to the back edge (edge on the X2 side) in the X-axis direction. The bottom surface of the left recesses 6L illustrated in FIG. 7A correspond to the combination of the front side surface, the bottom surface, and the back side surface of the left recesses 6L illustrated in FIG. 6B. The left side surface and the right side surface of the left recesses 6L illustrated in FIG. 7A are both flat vertical surfaces, but may be inclined flat surfaces or inclined curved surfaces. The inclined curved surface is typically a curved surface convex downward.

The difference between the left recesses 6L illustrated in FIG. 7B and the left recesses 6L illustrated in FIG. 6B is that both the front side surface and the back side surface of the former recesses are flat inclined surfaces whereas both the front side surface and the back side surface of the latter recesses are flat vertical surfaces. Specifically, the front side surface of the left recesses 6L illustrated in FIG. 7B is an inclined flat surface configured such that the angle between the upper surface of the left base member 11L and the front side surface is an angle α, and the back side surface of the left recesses 6L is an inclined flat surface configured such that the angle between the upper surface of the left base member 11L and the back side surface is an angle β. The inclined flat plate may be replaced with an inclined curved surface. The left side surface and the right side surface of the left recesses 6L illustrated in FIG. 7B are both flat vertical surfaces, but may be inclined flat surfaces or inclined curved surfaces. The inclined curved surface is typically a curved surface convex below.

The difference between the left recesses 6L illustrated in FIG. 7C and the left recesses 6L illustrated in FIG. 6B is that the former recesses are formed to penetrate the left base member 11L whereas the latter recesses are not formed to penetrate the left base member 11L. Although both the front side surface and the back side surface of the left recesses 6L illustrated in FIG. 7C are flat vertical surfaces, they may be inclined flat surfaces or inclined curved surfaces. In addition, although both the left side surface and the right side surface of the left recesses 6L illustrated in FIG. 7C are flat vertical surfaces, they may be inclined flat surfaces or inclined curved surfaces.

The configurations illustrated in FIG. 7A and FIG. 7B, have the effect of making it easier for a worker to scrape out any foreign matter inside the left recesses 6L to outside the left recesses 6L by a cotton swab or the like than in the configuration illustrated in FIG. 6B. The configuration illustrated in FIG. 7C has the effect that no foreign matter will be accumulated in the left recesses 6L.

Referring now to FIGS. 8A to 8F, other configuration examples of the recesses 6 will be described. FIGS. 8A to 8F each illustrate other configuration examples of the recesses 6. Specifically, FIGS. 8A to 8F each illustrate a top view of the left base member 11L in which the left recesses 6L and the left V-groove group 17L are formed, and correspond to FIG. 6A. The following description referring to FIGS. 8A to 8F relates to the left recesses 6L formed in the left base member 11L, but can also be applied to the right recesses 6R formed in the right base member 11R.

A difference between each of a first left recess 6L1 to a fourth left recess 6L4 included in the left recesses 6L illustrated in FIG. 8A and the left recesses 6L illustrated in FIG. 6B is that the former recesses cross only some V-grooves of the V-grooves (the first left V-groove 17AL to the fourth left V-groove 17DL) included in the left V-groove group 17L, i.e., do not cross the left V-groove group 17L over the entire width (length L1) of the left V-groove group 17L, whereas the latter recesses cross the left V-groove group 17L over the entire width (length L1) of the left V-groove group 17L. Another difference between the left recesses 6L illustrated in FIG. 8A and the left recesses 6L illustrated in FIG. 6B is that the former recesses include four recesses (the first left recess 611 to the fourth left recess 6L4) that are arranged side by side in the Y-axis direction, whereas the latter recesses include two recesses (the first left recess 6L1 and the second left recess 6L2) that are arranged side by side in the Y-axis direction.

Specifically, the first left recess 6L1 and the third left recess 6L3 are formed to cross the third left V-groove 17CL and the fourth left V-groove 17DL, which are some V-grooves of the V-grooves included in the left V-groove group 17L. The second left recess 6L2 and the fourth left recess 614 are formed to cross the first left V-groove 17AL and the second left V-groove 17BL, which are some V-grooves of the V-grooves included in the left V-groove group 17L. In other words, the first left recess 611 and the third left recess 6L3 are formed to not cross the first left V-groove 17AL and the second left V-groove 17BL. The second left recess 612 and the fourth left recess 6L4 are formed to not cross the third left V-groove 17CL and the fourth left V-groove 17DL.

A difference between the left recesses 6L illustrated in FIG. 8B and the left recesses 6L illustrated in FIG. 6B is that the former recesses are formed so as to cross the left V-groove group 17L obliquely, whereas the latter recesses are formed so as to cross the left V-groove group 17L perpendicularly. Another difference between the left recesses 6L illustrated in FIG. 8B and the left recesses 6L illustrated in FIG. 6B is that the former recesses include five recesses (a first left recess 6L1 to a fifth left recess 6L5) that are arranged side by side in the Y-axis direction, whereas the latter recesses include two recesses (the first left recess 6L1 and the second left recess 6L2) arranged side by side in the Y-axis direction.

Specifically, the first left recess 6L1 is formed so as to obliquely cross the first left V-groove 17AL and the second left V-groove 17BL, which are some V-grooves of the V-grooves included in the left V-groove group 17L. The second left recess 612 to the fourth left recess 614 are formed so as to obliquely cross the four V-grooves (the first left V-groove 17AL to the fourth left V-groove 17DL), i.e., all of the V-grooves included in the left V-groove group 17L. The fifth left recess 6L5 is formed so as to obliquely cross the third left V-groove 17CL and the fourth left V-groove 17DL, which are some V-grooves of the V-grooves included in the left V-groove group 17L.

The difference between the left recesses 6L illustrated in FIG. 8C and the left recesses 6L illustrated in FIG. 6B is that the former recesses include two recesses (a first left recess 6L1 and a second left recess 612) that cross each other, whereas the latter recesses include two recesses (the first left recess 6L1 and the second left recess 6L2) that do not cross each other.

Specifically, the first left recess 6L1 illustrated in FIG. 8C is formed so as to obliquely cross all of the four V-grooves (the first left V-groove 17AL to the fourth left V-groove 17DL) from the left front side of the left V-groove group 17L to the right back side of the left V-groove group 17L. Further, the second left recess 612 illustrated in FIG. 8C is formed so as to obliquely cross all of the four V-grooves (the first left V-groove 17AL to the fourth left V-groove 17DL) from the left back side of the left V-groove group 17L to the right front side of the left V-groove group 17L. The first left recess 6L1 and the second left recess 6L2 illustrated in FIG. 8C are formed so as to cross each other in the central area of the left V-groove group 17L.

A difference between the left recesses 6L illustrated in FIG. 8D and the left recesses 6L illustrated in FIG. 6B is that the length L2 of the former recesses is the same as the length L1 of the left V-groove group 17L, whereas the length L2 of the latter recesses is longer than the length L1 of the left V-groove group 17L. Another difference between the left recesses 6L illustrated in FIG. 8D and the left recesses 6L illustrated in FIG. 6B is that the former recesses include five recesses (a first left recess 6L1 to a fifth left recess 6L5) that are arranged side by side in the Y-axis direction, whereas the latter recesses include two recesses (the first left recess 6L1 and the second left recess 6L2) that are arranged side by side in the Y-axis direction.

Specifically, the front edges (edges on the X1 side) of the five recesses (the first left recess 6L1 to the fifth left recess 6L5) are formed to coincide with the front edge (edge on the X1 side) of the first left V-groove 17AL, and the back edges (edges on the X2 side) of the five recesses (the first left recess 6L1 to the fifth left recess 6L5) are formed to coincide with the back edge (edge on the X2 side) of the fourth left V-groove 17DL.

The left edge (edge on the Y1 side) of the first left recess 6L1 illustrated in FIG. 8D is formed to coincide with the left edge (edge on the Y1 side) of the left base member 11L. That is, the first left recess 6L1 illustrated in FIG. 8D is formed such that its left side is opened, i.e., opened in the left side surface of the left base member 11L.

A difference between the left recess 6L illustrated in FIG. 8E and the left recesses 6L illustrated in FIG. 6B is that the former recess is constituted by one recess (groove), whereas the latter recesses include two recesses (the first left recess 6L1 and the second left recess 6L2) that are arranged side by side in the Y-axis direction. Another difference between the left recess 6L illustrated in FIG. 8E and the left recesses 6L illustrated in FIG. 6B is that the width W2 of the former recess is not constant in the X-axis direction, whereas the width W2 of the latter recesses is constant in the X-axis direction.

Specifically, the left recess 6L illustrated in FIG. 8E is formed such that the width W2 at each of the front edge (edge on the X1 side) and the back edge (edge on the X2 side) is the maximum width W2a, and the width W2 in the center is the minimum width W2b.

A difference between the left recesses 6L illustrated in FIG. 8F and the left recesses 6L illustrated in FIG. 6B is that the former recesses are formed so as to extend while being curved in the X-axis direction, whereas the latter recesses are formed so as to extend linearly in the X-axis direction. Another difference between the left recesses 6L illustrated in FIG. 8F and the left recesses 6L illustrated in FIG. 6B is that the former recesses include four recesses (a first left recess 6L1 to a fourth left recess 6L4) that are arranged side by side in the Y-axis direction, whereas the latter recesses include two recesses (the first left recess 6L1 and the second left recess 6L2) that are arranged side by side in the Y-axis direction.

Specifically, each of the first left recess 6L1 to the fourth left recess 614 is formed so as to be curved to be convex to the Y2 side in the top view while maintaining a constant width W2.

A difference between the left recesses 6L illustrated in FIG. 8G and the left recesses 6L illustrated in FIG. 6B is that the former recesses are formed to be offset to one side of the upper surface of the left base member 11L, whereas the latter recesses are formed without being offset to one side of the upper surface of the left base member 11L. Another difference between the left recesses 6L illustrated in FIG. 8G and the left recesses 6L illustrated in FIG. 6B is that the width W2 of the former recesses is not constant in the X-axis direction, whereas the width W2 of the latter recesses is constant in the X-axis direction. Yet another difference between the left recesses 6L illustrated in FIG. 8G and the left recesses 6L illustrated in FIG. 6B is that the former recesses include four recesses (a first left recess 6L1 to a fourth left recess 6L4) that are arranged side by side in the Y-axis direction, whereas the latter recesses include two recesses (the first left recess 6L1 and the second left recess 6L2) that are arranged side by side in the Y-axis direction.

Specifically, the first left recess 6L1 to the fourth left recess 6L4 are formed to be offset to the left half of the upper surface of the left base member 11L. In other words, no recess is formed in the right half of the upper surface of the left base member 11L, which is the range enclosed by a dash-dot line. This means that no recess is formed in the range relatively close to the electrode rod 5 configured to generate an arc discharge, but recesses 6 are formed in the range relatively far from the electrode rod 5. This is to ensure that a part of the left optical fiber group 3L set in the left V-groove group 17L that is relatively close to the electrode rod 5 is reliably supported by the left V-groove group 17L.

In the example illustrated in FIG. 8G, the first left recess 6L1 and the third left recess 6L3 are each formed so as to widen from the front edge (edge on the X1 side) to the back edge (edge on the X2 side), and the second left recess 612 and the fourth left recess 614 are each formed so as to narrow from the front edge (edge on the X1 side) to the back edge (edge on the X2 side).

The left recesses 6L, which can have various configurations as illustrated in FIGS. 8A to 8G, facilitate a worker to drop a foreign matter entering the left V-groove group 17L into the left recesses 6L by a cotton swab or the like. Therefore, the left recesses 6L, which can have various configurations as illustrated in FIGS. 8A to 8G, can reduce the frequency of a situation in which optical fibers are set in the V-grooves while the foreign matter remains in the V-groove. As a result, the left recesses 6L, which can have various configurations as illustrated in FIGS. 8A to 8G, can inhibit the optical fibers set in the V-grooves from being displaced from predetermined positions by the foreign matter. For example, a worker cleaning the left V-groove group 17L using a cotton swab can drop the foreign matter in a V-groove into the nearest left recess 6L by moving the tip of the cotton swab along the extending direction (Y-axis direction) of the V-groove with the tip of the cotton swab kept in contact with the V-groove. Then, the worker can scrape the foreign matter in the left recess 6L out of the left recess 6L by moving the tip of the cotton swab along the extending direction (X-axis direction) of the left recess 6L with the tip of the cotton swab kept in contact with the bottom surface of the left recess 6L.

In the examples illustrated in FIGS. 8A to 8G, the right edge (the edge on the Y2 side) of the right-most recess among the plurality of recesses is formed so as not to coincide with the right edge (the edge on the Y2 side) of the left base member 11L. That is, the right-most recess among the plurality of recesses is formed such that its right side is not opened (i.e., not opened to the right side surface of the left base member 11L). This is to ensure that a portion of the left optical fiber group 3L set in the left V-groove group 17L relatively close to the electrode rod 5 is reliably supported by the left V-groove group 17L.

In the examples illustrated in FIGS. SA to 8G, the plurality of recesses are formed such that they are evenly spaced. However, the plurality of recesses may be formed such that they are unevenly spaced.

In the examples illustrated in FIGS. 8A to 8G, the one or the plurality of recesses are formed so as to have a front side surface (X1 side surface) and a back side surface (X2 side surface). That is, the one or the plurality of recesses are formed so that neither the front side nor the back side thereof is opened. However, the one or the plurality of recesses may be configured such that at least one of the front side and the back side thereof is opened. For example, the first left recess 611 illustrated in FIG. 8A may be configured such that its back end is opened to the back side surface of the left base member 11L.

As described above, the fusion splicer 1 according to the embodiment of the present disclosure is configured to be able to fuse and splice the first left optical fiber 3AL. The fusion splicer 1 is provided with a left base member 11L having a first left V-groove 17AL in which the first left optical fiber 3AL is set. In addition, a left recess 6L crossing the first left V-groove 17AL is formed in the left base member 11L.

In this configuration, by forming a recess to cross a V-groove, it is possible to reduce the probability that foreign matter will remain in the V-groove after the V-groove is cleaned by a cotton swab or the like. Therefore, it is possible to inhibit the foreign matter from being caught between the optical fiber and the V-groove, and in turn, it is possible to inhibit the optical fiber set in the V-groove from being displaced from a predetermined position due to the foreign matter. Moreover, this configuration has the effect that a worker cleaning a V-groove using a cotton swab or the like can easily drop the foreign matter in the V-groove into the nearest recess 6.

The left base member 11L is typically configured such that the depth D2 of the first left recess 6L1 is deeper than the depth D1 of the left V-groove group 17L, as illustrated in FIG. 6B. Specifically, the left base member 11L is typically configured such that the depth D2 of the first left recess 6L1 and the second left recess 6L2 is deeper than all of the four V-grooves (first left V-groove 17AL, second left V-groove 17BL, third left V-groove 17CL, and fourth left V-groove 17DL) that form the left V-groove group 17L.

This configuration has the effect of making it possible to inhibit foreign matter from being caught between the four optical fibers and the four V-grooves when the four optical fibers (first left optical fiber 3AL, second left optical fiber 3BL, third left optical fiber 3CL, and fourth left optical fiber 3DL) that form the left optical fiber group 3L are set in the four V-grooves, since the foreign matter scraped out from the V-groove group 17 falls into the left recesses 6L deeper than all of the four V-grooves. This configuration has the effect that the four optical fibers are accurately positioned in the four V-grooves.

The left base member 11L is typically formed such that the first left recess 6L1 extends in a direction that is not parallel with the extending direction (Y-axis direction) of the left V-groove group 17L, as illustrated in FIG. 6A. In the example illustrated in FIG. 6A, the left base member 11L is formed such that the first left recess 6L1 extends in a direction (X-axis direction) that is perpendicular to the extending direction (Y-axis direction) of the left V-groove group 17L.

This configuration has the effect that a worker cleaning the left V-groove group 17L can scrape out any foreign matter in a direction different from the extending direction (Y-axis direction) of the left V-groove group 17L by using a cotton swab or the like. That is, the worker can remove any foreign matter in the first left recess 6L1 to outside the first left recess 6L1 without returning it to the left V-groove group 17L. Therefore, this configuration has the effect of inhibiting an optical fiber set in a V-groove from being displaced from a predetermined position due to the foreign matter.

In addition, the bottom surface of the first left recess 6L1 may be formed so as to be smoothly deepened from the ends to the center. For example, as illustrated in FIGS. 7A and 7B, the bottom surface of the first left recess 6L1 may be formed so as to be smoothly deepened from the front end to the center and from the back end to the center in the extending direction (X-axis direction) of the first left recess 6L1.

This configuration has the effect that a worker cleaning the left V-groove group 17L can easily remove any foreign matter in the first left recess 6L1 to the outside using a cotton swab or the like. This is because there is no corner where any foreign matter will remain between the bottom surface and the wall surfaces of the first left recess 6L1.

The bottom surface of the first left recess 6L1 may be formed so as to be smoothly deepened from the center to the ends. This configuration has the effect that any foreign matter falling into the first left recess 6L1 can be collected at the ends of the first left recess 6L1.

The preferred embodiment of the present invention has been described in detail. However, the disclosed embodiments should be considered illustrative and not restrictive in all respects. The scope of the present invention is intended to be set forth in the claims, not the embodiments described above, and includes all modifications that are within the scope of the claims and the equivalents thereof. That is, the present invention is not limited to the embodiments described above. Various modifications, substitutions, or the like are applicable to the embodiments described above without departing from the scope of the present invention. In addition, each of the features described with reference to the embodiments described above may be combined appropriately, provided that they are not technically inconsistent.

For example, in the above-described embodiment, the fusion splicer 1 includes the left base member 11L having a plurality of V-grooves and a right base member 11R having a plurality of V-grooves. However, the fusion splicer 1 may include a left base member 11L having only one V-groove and a right base member 11R having only one V-groove. That is, the fusion splicer 1 may be a device configured to fuse and splice a single-core optical fiber.

### REFERENCE SIGNS LIST

1 - - - fusion splicer
3 - - - optical fiber group
3A - - - first optical fiber pair
3AL - - - first left optical fiber
3AR - - - first right optical fiber
3B - - - second optical fiber pair
3BL - - - second left optical fiber
3BR - - - second right optical fiber
3C - - - third optical fiber pair
3CL - - - third left optical fiber
3CR - - - third right optical fiber
3D - - - fourth optical fiber pair
3DL - - - fourth left optical fiber
3DR - - - fourth right optical fiber
3L - - - left optical fiber group
3R - - - right optical fiber group
4L - - - left tape core wire
4R - - - right tape core wire
5 - - - electrode rod
5B - - - back electrode rod
5Ba - - - tip
5F - - - front electrode rod
5Fa - - - tip
6 - - - recess
6L - - - left recess
6L1 - - - first left recess
6L2 - - - second left recess
6L3 - - - third left recess
614 - - - fourth left recess
615 - - - fifth left recess
6R - - - right recess
6R1 - - - first right recess
6R2 - - - second right recess
11 - - - base member
11L - - - left base member
11R - - - right base member
17 - - - V-groove group
17A - - - first V-groove pair
17AL - - - first left V-groove
17AR - - - first right V-groove
17B - - - second V-groove pair
17BL - - - second left V-groove
17BR - - - second right V-groove
17C - - - third V-groove pair
17CL - - - third left V-groove
17CR - - - third right V-groove
17D - - - fourth V-groove pair
17DL - - - fourth left V-groove
17DR - - - fourth right V-groove
17L - - - left V-groove group
17R - - - right V-groove group
21 - - - fiber clamp assembly
21A - - - arm portion
21AL - - - left arm portion
21AR - - - right arm portion
21B - - - fiber clamp
21BL - - - left fiber clamp
21BR - - - right fiber clamp
21C - - - coupling pin
21CL - - - left coupling pin
21CR - - - right coupling pin
21D - - - clamp block
21DL - - - left clamp block
21DR - - - right clamp block
21L - - - left fiber clamp assembly
21R - - - right fiber clamp assembly
31 - - - fiber holder
31L - - - left fiber holder
31La - - - left fiber holder body
31Lb - - - left cover
31R - - - right fiber holder
31Ra - - - right fiber holder body
31Rb - - - right cover
51 - - - imaging device
52 - - - fusion device
53 - - - fiber clamp driving device
54 - - - fiber holder driving device
55 - - - display device
60 - - - control device
G - - - foreign matter

1. A fusion splicer for fusing and splicing one or a plurality of optical fibers with another or other optical fibers, comprising:
a base member having one or a plurality of V-grooves in which the one or the plurality of optical fibers are set, wherein one or a plurality of recesses crossing the one or the plurality of V-grooves are formed in the base member.

2. The fusion splicer of claim 1,
wherein a depth of the one or the plurality of recesses is deeper than a depth of the one or the plurality of V-grooves.

3. The fusion splicer of claim 1,
wherein the one or the plurality of recesses are formed so as to extend in a direction non-parallel with an extending direction of the one or the plurality of V-grooves.

4. The fusion splicer of claim 1,
wherein a bottom surface of the one or the plurality of recesses is formed so as to be smoothly deepened from ends to a center thereof.

5. The fusion splicer of claim 1,
wherein the one or the plurality of recesses are through-holes penetrating the base member.
